(19) United States
(12) Patent Application Publication
(10) Pub. No.: US 2025/0247866 A1
(43) Pub. Date: Jul. 31, 2025

(54) SHARING OF CHANNEL OCCUPANCY TIME BY USER DEVICES FOR A SIDELINK COMMUNICATION IN AN UNLICENSED SPECTRUM

(71) Applicant: FRAUNHOFER-GESELLSCHAFT ZUR FOERDERUNG DER ANGEWANDTEN FORSCHUNG E.V., Muenchen (DE)

(72) Inventors: Thomas WIRTH, Berlin (DE); Sarun SELVANESAN, Berlin (DE); Baris GOEKTEPE, Berlin (DE); Thomas FEHRENBACH, Berlin (DE); Thomas SCHIERL, Berlin (DE); Cornelius HELLGE, Berlin (DE)

(21) Appl. No.: 19/086,095

(22) Filed: Mar. 20, 2025

Related U.S. Application Data
(63) Continuation of application No. PCT/EP2023/076858, filed on Sep. 28, 2023.

(30) Foreign Application Priority Data
Sep. 29, 2022 (EP) 22198731.6

(51) Int. Cl. H04W 72/25; H04L 5/00; H04W 72/30

(52) U.S. Cl. CPC H04W 72/25; H04L 5/0094; H04W 72/30

(57) ABSTRACT

A user device, UE, for a wireless communication network, like a 3^{rd} Generation Partnership Project, 3GPP, network, is described. The UE is to perform a sidelink, SL, communication using a channel comprising resources from an unlicensed spectrum and is to occupy the channel within a channel occupancy time, COT. The UE is to receive one or more control messages, wherein at least one of the control messages is related to one or more upcoming SL transmissions by one or more network entities of the wireless communication network. The UE is to determine, using the one or more control messages, among the one or more network entities, at least one network entity having an upcoming transmission, and share the COT with the at least one network entity.

### CROSS-REFERENCE TO RELATED APPLICATIONS

This application is a continuation of copending International Application No. PCT/EP2023/076858, filed Sep. 28, 2023, which is incorporated herein by reference in its entirety, and additionally claims priority from European Application No. EP 22198731.6, filed Sep. 29, 2022, which is also incorporated herein by reference in its entirety.

The present invention concerns the field of wireless communication systems or networks, more specifically, a direct communication between user devices over a sidelink using resources in the unlicensed spectrum, also referred to as SL-U. Embodiments concern the sharing of a channel occupancy time by user devices for the sidelink communication using resources from the unlicensed spectrum.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110, accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116, to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 3GPPs NR, New Radio, or within LTE-U, LTE Unlicensed or NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or NR, New Radio.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

FIG. 2(a) is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X. Thus, in Mode 1, a SL UE, e.g., UE 202 is connected via Uu interface to the gNB, and the gNB coordinates the resources for UE 202 be used to transmit control and/or data to another UE, e.g., UE 204, via a SL interface, which is referred to in NR as PC5.

FIG. 2(b) is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance.

Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2(b) which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2(a), in addition to the NR mode 1 or LTE mode 3 UEs 202, 204 also NR mode 2 or LTE mode 4 UEs 206, 208, 210 are present. In addition, FIG. 2(b), schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210. Thus, the SL UEs, e.g., UEs 206-210, need not to have a connectivity to the gNB, and perform a sensing & access resource allocation or a random access-based resource allocation, e.g., when transmitting from UE 206 to UE 208. Nevertheless, basic configurations need to be available for the UEs 206-210, in order to successfully exchange data. This information may be pre-configured or may be configured while a UE is within coverage of the gNB. For this the gNB may provide a basic configuration, e.g., basic information, which may be transported via a broadcast channel, e.g., using system information blocks (SIBs). The BS may also assist Mode 2 UEs to provide basic information on which resource pool (RP) is to be used or may act as a synchronization source.

Although FIG. 2(a) and FIG. 2(b) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements of the sidelink in a wireless communication system or network.

### SUMMARY

An embodiment may have a user device, UE, for a wireless communication network, like a 3^{rd} Generation Partnership Project, 3GPP, network, wherein the UE is to perform a sidelink, SL, communication using a channel including resources from an unlicensed spectrum, wherein the UE is to occupy the channel within a channel occupancy time, COT, wherein the UE is to receive one or more control messages, wherein at least one of the control messages is related to one or more upcoming SL transmissions by one or more network entities of the wireless communication network, and wherein, the UE is to determine, using the one or more control messages, among the one or more network entities, at least one network entity having an upcoming transmission, and share the COT with the at least one network entity.

Another embodiment may have a wireless communication system, like a 3^{rd} Generation Partnership Project, 3GPP, system, including at least one user device, UE, wherein the at least UE is to perform a sidelink, SL, communication using a channel including resources from an unlicensed spectrum, wherein the at least UE is to occupy the channel within a channel occupancy time, COT, wherein the at least UE is to receive one or more control messages, wherein at least one of the control messages is related to one or more upcoming SL transmissions by one or more network entities of the wireless communication network, and wherein, the at least UE is to determine, using the one or more control messages, among the one or more network entities, at least one network entity having an upcoming transmission, and share the COT with the at least one network entity.

According to another embodiment, a method for operating a user device, UE, for a wireless communication network, like a 3^{rd} Generation Partnership Project, 3GPP, network, wherein the UE is to perform a sidelink, SL, communication using a channel including resources from an unlicensed spectrum, may have the steps of: occupying the channel within a channel occupancy time, COT, receiving one or more control messages, wherein at least one of the control messages is related to one or more upcoming SL transmissions by one or more network entities of the wireless communication network, determining, using the one or more control messages, among the one or more network entities, at least one network entity having an upcoming transmission, and sharing the COT with the at least one network entity.

### BRIEF DESCRIPTION OF THE DRAWINGS

Embodiments of the present invention will be detailed subsequently referring to the appended drawings, in which:

FIG. 1 is a schematic representation of an example of a terrestrial wireless network;

FIG. 2(a) is a schematic representation of an in-coverage scenario;

FIG. 2(b) is a schematic representation of an out-of-coverage scenario;

FIG. 3 is a schematic representation of a wireless communication system including a transmitter, like a base station, and one or more receivers, like user devices, UEs, implementing embodiments of the present invention;

FIG. 4 illustrates COT sharing in case a responding UE receives both the SCI and the data from the initiating UE and uses the COT for transmitting to a further UE;

FIG. 5 illustrates COT sharing in case a responding UE receives only the SCI associated with the data transmitted by the initiating UE and uses the COT for transmitting to a further UE;

FIG. 6 illustrates a wireless communication system including user devices and a base station in accordance with embodiments of the present invention;

FIG. 7 illustrates examples of COT sharing for UEs with future reservations; and

FIG. 8 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

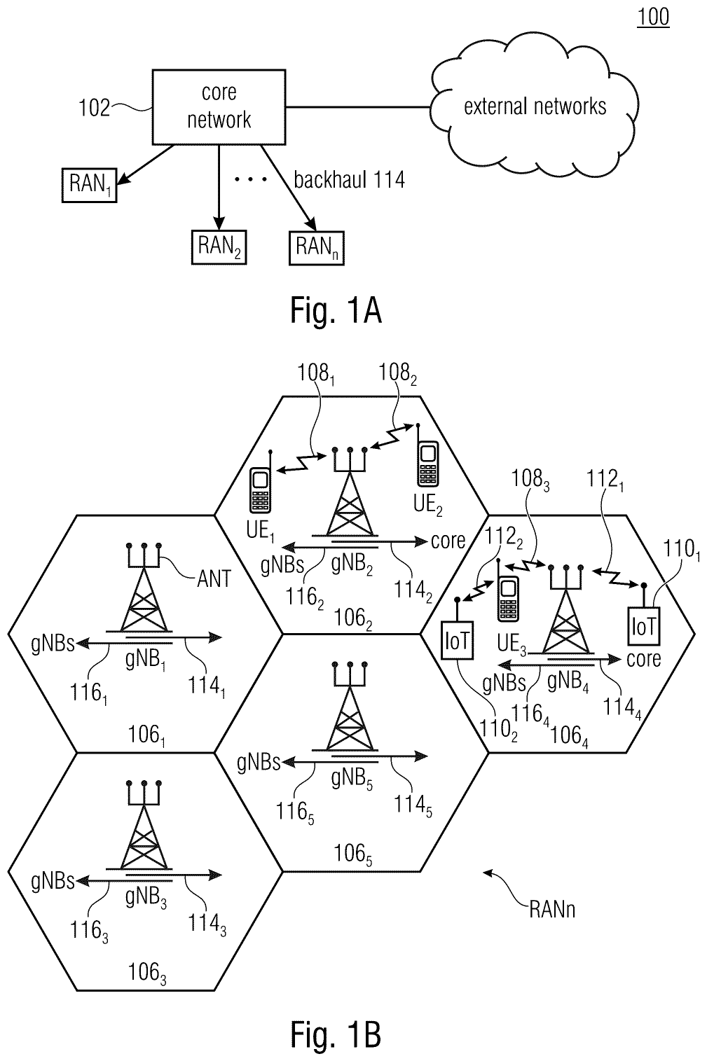

In mobile communication systems or networks, like those described above with reference to FIG. 1, for example in an LTE or 5G/NR network, the respective entities may communicate using one or more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier or subcarrier, a bandwidth part, BWP, a subband, a subchannel, and the like.

When using a single frequency band, the communication may be referred to as a single-band operation, e.g., a UE transmits/receives radio signals to/from another network entity on frequencies being within the band, like the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum.

Carrier aggregation, CA, is an example using two or more frequency bands in the licensed spectrum and/or in the unlicensed spectrum. Also mixed combinations are possible, e.g., one or more frequency bands in licensed and one or more frequency bands in unlicensed bands. Furthermore, CA may also be just used for aggregation of an additional carrier in one direction, e.g., as a supplemental carrier to improve transmissions via UL, DL or SL.

5G New Radio (NR) may support an operation in the unlicensed spectrum so that a single-band operation or a multi-band operation may include frequency bands or subbands in the unlicensed spectrum. The unlicensed spectrum may include bands with a potential IEEE 802.11 coexistence, such as frequency bands within the 5 GHz and/or the 6 GHz spectrum. NR-U may support bandwidths that are an integer multiple of 20 MHz, for example due to regulatory requirements. The splitting into the subbands may be performed so as to minimize interference with coexisting systems, like IEE 802.11 systems, which may operate in one or more of the same bands with the same nominal bandwidth channels, like 20 MHz channels. Other examples, of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands, Listen-before-talk, LBT, may be performed separately per subband. This may lead to a situation in which one or more of the subbands are busy or occupied due to an interference, for example, from other communication systems coexisting on the same band, like other public land mobile networks, PLMNs or systems operating in accordance with the IEEE 802.11 specification or operating under the ETSI Broadband Radio Access Networks, BRAN, specifications. In such a situation, the transmitter, either the transmitting gNB or the transmitting UE, is only allowed to transmit on the subbands which are detected to be not busy, also referred to as subbands being free or non-occupied. For example, for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy, or non-won subbands.

For accessing resources or channels in the unlicensed spectrum, a so-called NR-U channel access is to be performed, which makes use of a channel access procedure, which is a procedure based on sensing that evaluates the availability of a channel for performing transmissions. The basic unit for sensing may be a sensing slot with a certain duration, e.g., Tₛₗ=9 μs. The sensing slot duration Tₛₗ is considered to be idle if a base station or a UE senses the channel during the sensing slot duration and determines that the detected power is less than an energy detection threshold for at least a certain time, like 4 μs. within the sensing slot duration. Otherwise, the sensing slot duration is considered to be busy. In case a channel is available or not busy, one or more transmission may be performed on the channel, and the so-called channel occupancy refers to the one or more transmissions on the one or more channels by the base station or UE after performing the corresponding channel access procedure. A channel occupancy time, COT, refers to the total time for which the base station or UE and any other base station or UE may share the channel occupancy to perform one or more transmissions on the channel after the base station or UE has performed the channel access procedure, CAP.

For determining a channel occupancy time, if a transmission gap is less than or equal to a certain period, like 25 μs, the gap duration is counted in the channel occupancy time. A channel occupancy time may be shared for a transmission between a base station and a corresponding UE.

Several types of channel access procedures, CAPs, may exist, e.g.:
Type-1 CAP The time duration for which the sensed channel has be idle before the transmission may be random. For example, a base station or a UE may determine an initial counter N which is randomly selected to be between 0 and CWₚ, where CW_{min,p}≤CWₚ≤CW_{max,p}, with CW_{min,p} and CW_{max,p} being subject to the channel access procedure class, CAPC. When the channel is sensed to be idle for a certain period of time, the value of N is decreased, and a transmission may take place only once N reaches 0.
Type-2A: The time duration for which the sensed channel has be idle before the transmission may be deterministic, and the and the channel may need to be idle for two sensing slots (e.g. at the beginning and end) within a sensing interval of a first duration, like 25 μs.
Type-2B: The time duration for which the sensed channel has be idle before the transmission may be deterministic, and the channel may need to be idle for one sensing slot within a sensing interval of a second duration shorter than the first duration, like 16 μs.
Type-2C: This type does not perform any sensing of the channel before the transmission, and the duration of a corresponding transmission may have a predefined duration, e.g., may be at most 584 μs. This may also be referred to as an LBT-less CAP.

Once a UE has performed the channel access procedure, CAP, the UE occupies the given band or channel in which it performed the CAP and the COT begins. The UE is also referred to as the initiating UE. It is also possible for the initiating UE to share the COT with another gNB or with another UE, also referred to as the responding UE, in the case of a sidelink communication, SL-U, using resources from an unlicensed spectrum, like an unlicensed SL resource pool, SL-U RP, including a plurality of resources from an unlicensed spectrum to be used for SL transmissions. For a sidelink communication, SL-U, using the unlicensed spectrum, when an initiating UE shares the COT with another or responding UE, also referred to as UE-to-UE COT sharing, despite the fact that the responding UE uses the shared COT for which the initiating UE has already performed a CAP, like an LBT, it is required for the responding UE to check the availability of the shared channel using a CAP. The CAP employed by the responding UE may be shorter than the CAP employed by the initiating UE, for example a shorter LBT, such as the above-referenced Type-2A or Type-2B CAPs. In case the responding UE transmits a feedback, like a PSFCH, which may be categorized as a short transmission since the feedback spans only two or three symbols, the UE may also perform Type-2C CAP without carrying out any LBT, e.g. LBT-less CAP.

Conventionally, UE-to-UE COT sharing is considered for two cases or alternatives:
Alternative 1:
A responding SL-UE may utilize a COT shared by the COT initiating UE in case the responding SL-UE is a target receiver of the PSSCH data transmission performed by the COT initiating UE during the COT.
Alternative 2:
The responding SL-UE may utilize a COT shared by a COT initiating UE in case the responding SL-UE is a target receiver of a control message transmission, like a SCI, performed by the COT initiating UE during the COT.

Thus, for both alternatives the condition that an initiating UE may share the COT with another or responding UE is that the responding UE is the mentioned target receiver. The initiating UE may provide COT sharing information to the responding UE using sidelink control information, SCI. Since the SCI is transmitted in the PSCCH, all UEs in the range of the initiating UE receive the COT sharing information. In accordance with the above-mentioned alternative 1, the main restriction is that only UEs that received the SCI along with the data transmission may use the shared COT, whereas, in accordance with alternative 2, it is sufficient for the UE to receive only the SCI that contains the COT sharing information and is hence referred to as a target receiver. Another condition that is applicable to both alternatives mentioned above is that the COT initiating UE has to be a target receiver of the transmission that the responding UE is transmitting on the shared COT.

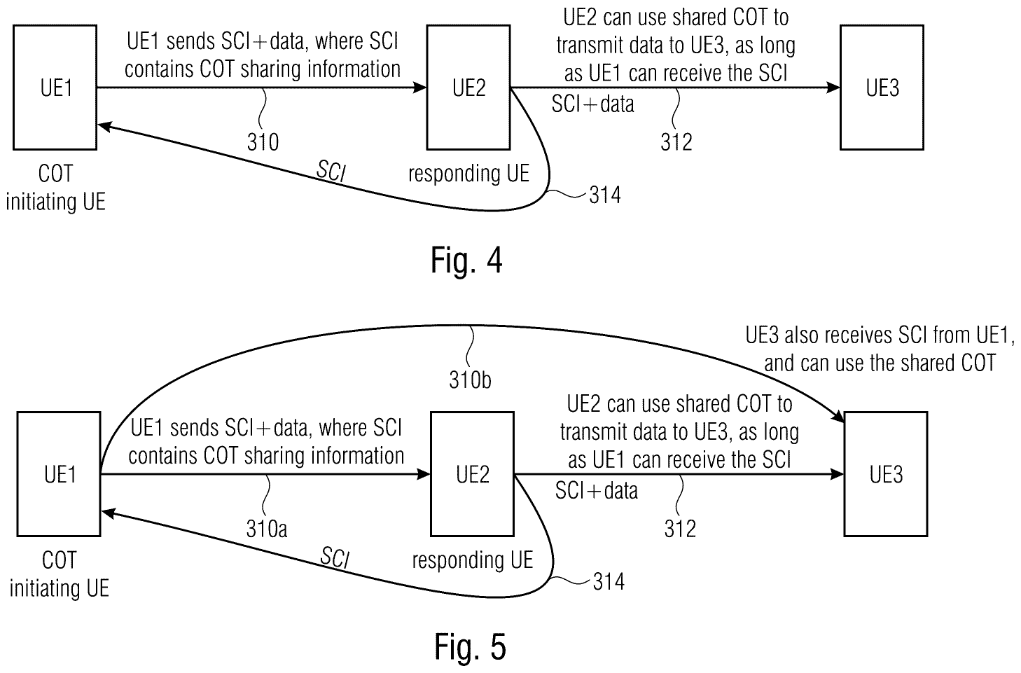

Thus, there are basically four options for operating the responding UE, based on two factors
namely based on what the responding UE received from the initiating UE, and what the initiating UE receives when the responding UE uses the COT.
   Option 1:
   Assuming that the responding UE receives both the SCI and the data from the initiating UE, as in alternative 1, the initiating UE also receives both an SCI and data from the responding UE using the shared COT.
   Option 2:
   Assuming that the responding UE receives both the SCI and the data from the initiating UE, as in alternative 1, the initiating UE may receive only the SCI from the responding UE using the shared COT.
   This is illustrated in FIG. 4 which shows the COT initiating UE, UE1, and the responding UE, UE2. UE1 performed a channel access procedure for a certain band or channel including resources from the unlicensed spectrum, and following the successful CAP occupies the channel for a certain duration of the COT. As is schematically illustrated at 310, UE1 performs a transmission by sending the SCI and the data associated with the SCI. In addition, the SCI includes the COT sharing information.
   In accordance with Option 2, UE2 makes use of the COT sharing information so as to share the COT initiated by UE1 for performing transmissions. As is illustrated at 312, UE2 may use the shared COT to transmit data to a further UE, UE3, provided UE1 also receives the SCI associated with the data transmitted from UE2 to UE3, as is schematically illustrated in FIG. 4 at 314.
   Option 3:
   Assuming the responding UE receives only the SCI from the initiating UE, as in alternative 2, the initiating UE may receive from the responding UE both the SCI and data.
   Option 4:
   Assuming the responding UE receives only the SCI from the UE, as in alternative 2, the initiating UE may receive also only an SCI from the responding UE using the shared COT, as is schematically illustrated in FIG. 5.
   FIG. 5 illustrates the COT initiating UE, UE1, the responding UE, UE2, and a further UE, UE3, which may communicate with each other over the sidelink resources in an unlicensed spectrum. After occupying the channel and establishing the COT, UE1 performs a transmission which is neither directed to UE2 nor to UE3, however, the SCI associated with the transmission is received at both the UE2 and the UE3, as is schematically illustrated at 310a and 310b. The SCI provided by UE1 contains the COT sharing information so as to allow either one of UE2 and UE3 to use the shared COT to perform a transmission.
In FIG. 5 it is assumed that UE2 performs a data transmission to UE3 using the shared COT in the same way as described above with reference to FIG. 4, and that the SCI associated with the transmission from UE2 to UE3 is also received at UE1, as is schematically illustrated at 314.

When considering the above-described options, one may see that all options assume that UE2 and UE3 may share the COT responsive to receiving an SCI from UE1. While in Options 1 and 2 the relationship between UE1 and UE2 may be clear in that only the UE that received both the SCI and the data transmission, namely UE2 in the mentioned options, may share the COT initiated by UE1, at least Options 3 and 4 allow any one of the UEs in the range of UE1 which receives the SCI, as indicated at 310a, 310b in FIG. 5, namely UE2 or UE3, to share the COT. Thus, there is either only a limited control (Options 1 and 2) which UEs may share a COT, or there may be no control at all which of the other UEs may actually share the COT (Options 3 and 4). This is disadvantageous because in case of no control of COT sharing, as described above, in a crowded scenario with many UEs trying to transmit in the unlicensed spectrum, too many UEs might compete to grab the COT and transmit. This leads to a higher number of collisions and/or an increase in the interference among UEs trying to decode control and/or data. On the other hand, if the control is limited, e.g., in case a UE may only share a COT with another UE if it has data to transmit to this said UE, this might be too restrictive since the responding UE may not benefit from a shared COT and has to perform a CAP itself. Thus, this wastes a valuable COT, which may be easily allocated by a COT-initiating UE, even without data, and which transmits COT-sharing information as control to another UE. Furthermore, additional CAPs lead to additional delay, so COT sharing without these constraints improves delay-constraint data transmission in unlicensed spectrum.

Embodiments of the present invention address the above issues by providing an approach in accordance with which an initiating UE, also referred to as a transmitting, TX, UE, determines one or more further network entities (e.g., a further UE, a base station, BS, a roadside unit, RSU, or a WiFi device, etc.) to share the COT it initiated using previously received SCIs from one or more network entities in the vicinity of the initiating UE. Thus, in accordance with the inventive approach, not only the fact that the initiating UE performs a transmission on the occupied channel is considered but also the transmissions that may be scheduled by other network entities (so-called upcoming transmission) which is evaluated using the control messages associated with upcoming transmission, like SCIs. Thus, an improved control which of the network device (one or more thereof) may share the UE initiated COT is achieved, which provides the following advantages:
A COT-initiating UE may share the COT which increases the probability that another SL-U UE may use the COT to successfully transmit in the unlicensed spectrum.
Another advantage is that a COT-initiating UE may provide some further COT-sharing information in order to limit the use of the shared COT to a certain group of SL-U UEs, e.g., a group having a certain group ID, or to limit the use of the shared COT to packet transmission of packets having a certain priority, e.g., high priority packets based on 5G packet-per-packet priority, PPP.
Yet another advantage is that it decreases the CAP-burden on other UEs operating in SL-U. These UEs may reduce their sensing efforts. Reduced sensing also implies that these UEs may save power, e.g., also perform discontinuous reception, DRX, instead of receiving and decoding data. This is also especially beneficial for low power UEs, e.g., pedestrian UEs, P-UEs, which may have limited battery supply.

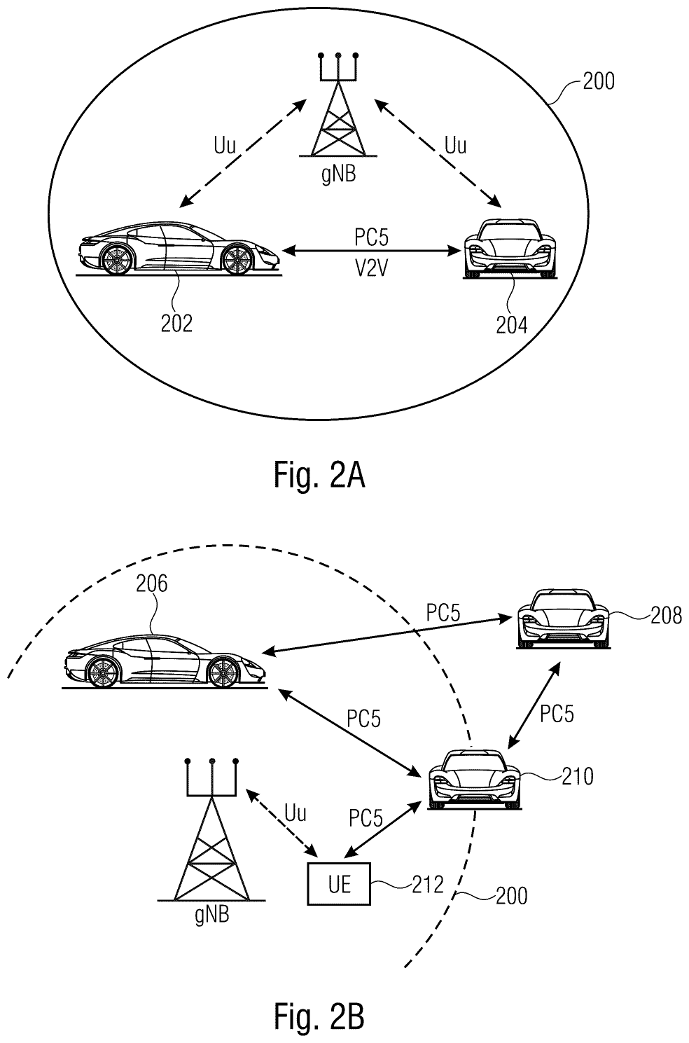

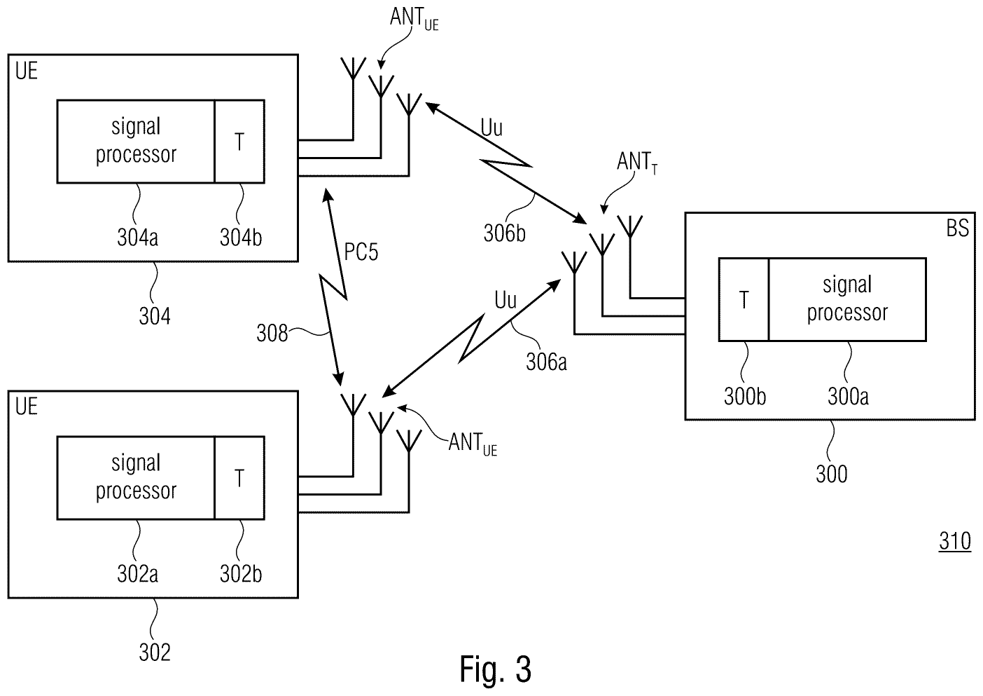

Embodiments of the present invention may be implemented in a wireless communication system as depicted in FIG. 1, FIG. 2(a) or FIG. 2(b) including base stations and users, like mobile terminals or IoT devices. FIG. 3 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 3, the one or more UEs 302, 304 of FIG. 3, and the base station 300 of FIG. 3 may operate in accordance with the inventive teachings described herein.

### UE Initiating COT

The present invention provides a user device, UE, for a wireless communication network, like a 3^{rd} Generation Partnership Project, 3GPP, network,
wherein the UE is to perform a sidelink, SL, communication using a channel comprising resources from an unlicensed spectrum,
wherein the UE is to occupy the channel within a channel occupancy time, COT,
wherein the UE is to receive one or more control messages, wherein at least one of the control messages is related to one or more upcoming SL transmissions by one or more network entities of the wireless communication network, and
wherein, the UE is to determine, using the one or more control messages, among the one or more network entities, at least one network entity having an upcoming transmission, and share the COT with the at least one network entity.

According to embodiments, the UE is to share the COT with
one network entity, in case of a frequency contiguous, non-interlaced transmission by the UE and/or by the network entity, or
more than one network entity, up to the number of interlaces, in case of an interlaced transmission by the UE and/or by the network entities, or
more than one network entity in case of a feedback transmission, e.g. over the Physical Sidelink Feedback Channel, PSFCH.

According to embodiments, the UE is to perform a transmission during a first part of the COT, and the network entity is to perform the upcoming transmission using all of or one or more portions of a second part of the COT, the second part of the COT comprising a duration of the COT which remains after the transmission of the UE is completed.

According to embodiments, wherein the UE is to share
a first portion of the second part of the COT for a feedback transmission, like a PSFCH, by a network entity receiving the transmission of the UE in the first part of the COT and/or by one or more other network entities, and/or
a second portion of the second part of the COT for a further transmission by the network entity or another network entity only after the feedback transmission is completed.

According to embodiments, the UE is to indicate the COT sharing for the first and/or second portions of the second part of the COT within a control message associated with the transmission performed by the UE in the first part of the COT, e.g., an SCI message, or a control message associated with the transmission of an earlier portion within the second part of the COT, e.g., via an SCI message.

According to embodiments, the UE is to share the second part of the COT with a network entity receiving the transmission from the UE in the first part of the COT for one or more of the following:
a feedback transmission, PSFCH,
a data transmission, PSSCH,
a control signaling, PSCCH,
a transmission of demodulation references symbols, DMRS,
an automatic gain control signal, AGC.

According to embodiments, the UE is to indicate the COT sharing for the second part of the COT within a control message associated with the transmission performed by the UE in the first part of the COT, e.g., an SCI message.

According to embodiments, the SCI message contains information on the slot structure to be used for transmissions in the second part of the COT, e.g., including any combination of one or more of
feedback only,
data only,
DMRS only,
feedback and data,
DMRS and feedback and data,
a remaining COT duration,
a priority of the COT,
a transmission range,
a transmission type, e.g. cast type,
feedback-less transmissions, etc.

According to embodiments, the feedback transmission, PSFCH, is performed by the network entity receiving the transmission performed by the UE in the first part of the COT, or by one or more further network entities.

According to embodiments,
within a time interval following the transmission by the UE, some or all of the upcoming transmissions by the network entities are performed at different times, and
the UE is to share the COT with a network entity performing the upcoming transmission at a particular point within the time interval, wherein the particular point comprises an earliest point or any other later point within the time interval.

According to embodiments, the time interval is defined by the remaining COT timer or by the COT duration.

According to embodiments, the UE is to receive the one or more control messages prior to occupying the channel.

According to embodiments, the UE is to occupy the channel for the COT responsive to
receiving from one or more of the network entities a grant indicating the channel or an interlace or a PSFCH index to be used by the UE, and/or
determining resources to be used within a channel based on sensing and resource selection procedures, and/or
a successful channel access procedure, CAP, performed by the UE on the channel.

According to embodiments, the one or more control messages comprise one or more of the following:
a sidelink control information, SCI, message,
a downlink control information, DCI, message,
a configured grant, CG, configuration,
a MAC-CE,
a RRC configuration,
an IUC, inter-UE coordination, message,
an AIM, assistance information message.

According to embodiments, the control message is transmitted within one or more of:
a 1st stage SCI,
a 2^{nd} stage SCI,
a PDCCH,
a Medium Access Control layer Control Element, MAC CE,
a Radio Resource Control, RRC, message, e.g., a SL-RRC message.

According to embodiments, in case of a SCI message, the UE is to determine, using a resource reservation or resource assignment information, e.g., a Time Resource Indicator Value, TRIV, and/or a Frequency Resource Indicator Value, FRIV, and/or an inter-UE coordination, message IUC, in the SCI message, whether an upcoming transmission by a network entity is to be performed during the COT.

According to embodiments, the resource assignment information includes a future resource reservation information using a Time Resource Indicator Value, TRIV, and/or a Frequency Resource Indicator Value, FRIV, and/or an Inter-UE Coordination message, IUC, included in the SCI message.

According to embodiments, in case of a SCI message for a periodic transmission, the UE is to determine, using a resource reservation periodicity in the SCI message and/or a resource reselection counter, whether an upcoming transmission by a network entity is to be performed during the COT.

According to embodiments, in case of a DCI message, the UE is to determine from the DCI the at least one network entity with which the UE will share the COT.

According to embodiments, in case of a CG configuration, the UE is to determine from the CG configuration the at least one network entity with which the UE will share the COT.

According to embodiments,
the UE is to receive a signaling indicating that COT sharing is enabled, or
the UE is to determine that COT sharing is enabled by a system level configuration or pre-configuration, e.g., a resource pool configuration.

According to embodiments, the signaling comprises one or more of the following:
a downlink control information, DCI, message,
a resource pool, RP, configuration,
a configured grant, CG, configuration,
a sidelink control information, SCI, message,
a downlink control information, DCI, message,
an IUC, inter-UE coordination, message,
an assistance information message, AIM.

According to embodiments, the signaling includes a flag indicating if COT sharing is enabled or not for a channel or interlace to be used by the UE.

According to embodiments, the signaling indicates a remaining COT time and/or a maximum COT time of the COT shared by the UE.

According to embodiments, the signaling indicates one or more of the following:
a maximum COT time,
certain conditions when COT sharing is enabled, e.g., COT sharing is enabled in case of one or more of the following:
   a remaining COT time is above a predefined threshold,
   an upcoming transmission to be performed by a network entity has a priority exceeding a predefined threshold,
   an upcoming transmission to be performed by a network entity has a particular identity, ID,
   an upcoming transmission to be performed by a network entity belongs to a certain UE group,
   an upcoming transmission to be performed by a network entity has enabled a feedback,
   a transmission to be performed by the UE or an upcoming transmission to be performed by a network entity has a predefined cast type,
   a communication range of a transmission to be performed by the UE or of an upcoming transmission by a network entity is below a predefined threshold,
   a network entity is located at a distance less than a predefined threshold away from the UE, like within a minimum communication range, MCR.

According to embodiments, the UE is to determine one or more of the following information from previously received SCIs from the network entities or from the signaling to determine the characteristics of an upcoming transmission:
a priority of an upcoming transmission,
an identification, ID, of the network entity, e.g., a UE ID,
a group ID with which the network entity is associated or is a part of,
whether feedback is enabled or disabled,
a cast type of the transmission,
a minimum communication range.

According to embodiments, the RP configuration indicates whether COT sharing is enabled or not for some or all of the resources or interlaces from an unlicensed SL resource pool, SL-U RP, the SL-U RP including a plurality of resources and/or interlaces from the unlicensed spectrum to be used for SL transmissions.

According to embodiments, for sharing the COT, the UE is to send a COT sharing control message to the network entity.

According to embodiments, the COT sharing control message is transmitted within one or more of:
a sidelink control information, SCI, message, e.g., a 1^{st} stage SCI and/or a 2^{nd} stage SCI,
a Medium Access Control layer Control Element, MAC CE,
a Radio Resource Control, RRC, message, e.g., a SL-RRC message.

According to embodiments, the UE is to provide COT sharing information within one or more of:
a 1^{st} stage SCI and a MAC CE, with the 1^{st} stage SCI indicating a Physical Sidelink Shared Channel, PSSCH, that contains the MAC CE which includes the COT sharing information,
a 2^{nd} stage SCI and a MAC CE, with the 2^{nd} stage SCI indicating a Physical Sidelink Shared Channel, PSSCH, that contains the MAC CE which includes the COT sharing information,
only a 1st stage SCI,
only a 2^{nd} stage SCI,
a 1^{st} stage SCI and a 2^{nd} stage SCI,
a 1st stage SCI and a 2^{nd} stage SCI and MAC CE, with the 1^{st} stage SCI and/or the 2^{nd} stage SCI indicating a Physical Sidelink Shared Channel, PSSCH, that contains the MAC CE which includes the COT sharing information,
only a MAC CE.

According to embodiments, the COT sharing information includes
a destination ID of the network entity, and/or
a feedback indicator, e.g. PSFCH indicator,
a remaining COT time, and/or
a maximum COT time.

According to embodiments, the COT sharing information is transmitted via unicast or groupcast or broadcast.

According to embodiments, the UE is to share the COT dependent on one or more conditions, e.g., dependent on one or more of the following:
a remaining COT time is above a predefined threshold,
a transmission to be performed by the UE and/or an upcoming transmission to be performed by a network entity has a priority exceeding a predefined threshold,
an upcoming transmission to be performed by a network entity has a particular identity, ID, or belongs to a certain UE group,
a transmission to be performed by the UE and/or an upcoming transmission to be performed by a network entity has enabled a feedback,
a transmission to be performed by the UE and/or an upcoming transmission to be performed by a network entity has a predefined cast type,
a remaining packet delay budget, PDB, of a transmission to be performed by the UE and/or an upcoming transmission to be performed by a network entity is above a predefined threshold,
a communication range of a transmission to be performed by the UE and/or an upcoming transmission to be performed by a network entity is below a predefined threshold,
a number of slots of a transmission to be performed by the UE and/or an upcoming transmission to be performed by a network entity is above a predefined threshold,
the network entity is located at a distance less than a predefined threshold away from the UE, like within a minimum communication range, MCR,
the network entity is located within a certain zone or geo-location.

### UE Sharing COT

The present invention provides a user device, UE, for a wireless communication network, like a 3^{rd} Generation Partnership Project, 3GPP, network,
wherein the UE is to perform a sidelink, SL, communication using a channel comprising resources from an unlicensed spectrum,
wherein the UE is to receive one or more control messages, wherein the control message is related to upcoming SL transmissions by one or more network entities of the wireless communication network, and
wherein the UE is to determine, using the one or more control messages, at least one network entity of the wireless communication system occupying a channel for a transmission within a channel occupancy time, COT, and perform a transmission within the shared COT using a full remaining COT or using only one or more parts of the remaining COT.

According to embodiments, the UE is to request the network entity to share the COT with the UE for one or more upcoming transmissions.

The present invention provides a user device, UE, for a wireless communication network, like a 3^{rd} Generation Partnership Project, 3GPP, network,
wherein the UE is to perform a sidelink, SL, communication using a channel comprising resources from an unlicensed spectrum,
wherein, responsive to a channel occupancy time, COT, sharing signaling from a network entity of the wireless communication system, the UE is to perform a transmission using a channel previously occupied by the network entity for a transmission by the network entity.

According to embodiments, the UE is to receive the one or more control messages prior to determining one or more network entities occupying the channel.

According to embodiments, wherein the network entity comprises a user device, UE, according to embodiments of the present invention.

According to embodiments, the network entity is to perform the transmission during a first part of the COT, and the UE is to perform the transmission using all of or one or more portions of a second part of the COT, the second part of the COT comprising a duration of the COT which remains after the transmission of the network entity is completed.

According to embodiments, the UE is to share
a first portion of the second part of the COT for a feedback transmission, PSFCH, for the transmission of the network entity in the first part of the COT, and
a second portion of the second part of the COT for a further transmission by the UE only after the feedback transmission is completed.

According to embodiments, the UE is to receive a COT sharing signaling for the first and/or second portions of the second part of the COT within a control message associated with the transmission performed by the network entity in the first part of the COT, e.g., a SCI message or a control message associated with the transmission of an earlier portion within the second part of the COT, e.g., via an SCI message.

According to embodiments, the UE is to share the second part of the COT with a network entity transmitting the transmission to the UE in the first part of the COT for one or more of the following:
a feedback transmission, PSFCH,
a data transmission, PSSCH,
a control signaling, PSCCH,
an automatic gain control, AGC, signaling,
a transmission of demodulation references symbols, DMRS.

According to embodiments, the UE is to receive a COT signaling for the second part of the COT within a control message associated with the transmission performed by the network entity in the first part of the COT, e.g., an SCI message.

According to embodiments, the SCI message contains information on the slot structure to be used for transmissions in the second part of the COT, e.g., including any combination of one or more of
feedback only,
data only,
DMRS only,
feedback and data,
DMRS and feedback and data,
automatic gain control, AGC, signaling,
feedback-less transmissions, etc.

According to embodiments, the feedback transmission, PSFCH, is performed by the UE or by one or more further network entities.

According to embodiments, the UE is to perform the transmission within the COT initiated by the network entity dependent on one or more conditions, e.g., dependent on one or more of the following:
a remaining COT time is above a predefined threshold,
a transmission to be performed by the UE and/or by the network entity has a priority exceeding a predefined threshold,
a transmission to be performed by the UE and by the network entity both have the same priority,
a transmission performed by the UE and/or by the network entity has enabled a feedback,
a transmission performed by the UE and/or by the network entity has a predefined cast type,
a remaining packet delay budget, PDB, of a transmission to be performed by the UE is above a predefined threshold,
a communication range of a transmission to be performed by the UE and/or by the network entity is below a predefined threshold.

According to embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

According to embodiments, the network entity comprises one or more of a further UE, like a UE or a SL UE or a group leader UE, GL-UE, or a base station, like a macro cell base station or a small cell base station or a central unit of a base station or a distributed unit of a base station or an Integrated Access and Backhaul, IAB, node, or a road side unit, RSU, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Network Entity Serving UE Initiating COT

The present invention provides a network entity for a wireless communication network, like a 3^{rd} Generation Partnership Project, 3GPP, network,
wherein the network entity is to serve a plurality of user devices, UEs, which are to communicate with each other over a sidelink, SL, using resources from an unlicensed spectrum,
wherein the plurality of UEs comprises a certain user device, UE, in accordance with embodiments of the present invention.

According to embodiments, the network entity is to signal to the certain UE a DCI message indicating a UE with which the certain UE is to share the COT.

According to embodiments, the DCI message may further include one or more of the following:
a flag indicating if COT sharing is enabled or not for a grant indicating the channel to be used by the UE,
a remaining COT time or a maximum COT time of the COT shared by the UE.

According to embodiments, the network entity is to signal to one or more certain UEs a resource pool configuration.

According to embodiments, the RP configuration further includes one or more of the following:
a flag indicating if COT sharing is enabled or not,
a list of flags indication if COT sharing is enabled or not depending on the transmission priority,
maximum COT time,
a list of maximum COT times depending on the transmission priority,

### System/Network

The present invention provides a wireless communication system, like a 3^{rd} Generation Partnership Project, 3GPP, system, comprising a one or more user devices, UEs, in accordance with embodiments of the present invention and/or one or more network entities in accordance with embodiments of the present invention.

According to embodiments, the base station comprises one or more of a macro cell base station, or a small cell base station, or a central unit of a base station, or a distributed unit of a base station, or an Integrated Access and Backhaul, IAB, node, or a road side unit, RSU, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides a method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises:
occupying the channel within a channel occupancy time, COT,
receiving one or more control messages, wherein at least one of the control messages is related to one or more upcoming SL transmissions by one or more network entities of the wireless communication network,
determining, using the one or more control messages, among the one or more network entities, at least one network entity having an upcoming transmission, and
sharing the COT with the at least one network entity.

The present invention provides a method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises:
receiving one or more control messages, wherein the control message is related to upcoming SL transmissions by one or more network entities of the wireless communication network,
determining, using the one or more control messages, at least one network entity of the wireless communication system occupying a channel for a transmission within a channel occupancy time, COT, and
performing a transmission within the shared COT using a full remaining COT or using only one or more parts of the remaining COT.

The present invention provides a method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises:
responsive to a channel occupancy time, COT, sharing signaling from a network entity of the wireless communication system, performing a transmission using a channel previously occupied by the network entity for a transmission by the network entity.

### Computer Program Product

Embodiments of the first aspect of the present invention provide a computer program product comprising instructions which, when the program is executed by a computer, causes the computer to carry out one or more methods in accordance with the present invention.

It is noted that in the description given herein, when referring to above mentioned “sharing of the channel occupancy” this is also referred to as a UE sharing the COT or using a shared COT. This means that the UE may successfully perform a CAP, and then either partially use or not use the COT, and share the remaining COT or the whole COT with another UE. From the perspective of a UE using the shared COT, the UE may use a channel initially occupied by another UE within or during at least a part of the COT that began in response to other UE occupying the channel. Furthermore, the UE occupying the channel not necessarily means that the UE is transmitting data on the COT, but that the given UE successfully performed a CAP for this COT and shares the COT, e.g., by transmitting control information regarding this COT to another UE or set of UEs, which may potentially occupy this COT for a control and/or data transmission.

Embodiments of the inventive aspect are now described in more detail with reference to the accompanying drawing. It is noted that the subsequently outlined and described aspects or embodiments may be combined such that some or all of the aspects/embodiments are implemented within one embodiment. Further, it is noted that when referring to “resources”, in this description, a resource is to be understood as comprising one or more of the following:
one or more symbols,
one or more time slots or subframes or frames,
one or more frequencies or carriers or subchannels or group of subchannels,
one or more interlaces,
one or more frequency bands, like unlicensed subbands,
one or more bandwidth parts,
one or more resource pools,
one or more LBT sub-bands,
one or more spatial resources, e.g., using spatial multiplexing.

Furthermore, it is noted that when referring to “a set of resources”, in this description, a set of resources may contain one or more than one resource, with the definition of a resource as mentioned above. Moreover, it is noted that when referring to a “channel”, in this description, this may refer to a set of the resources as mentioned above. Thus, a “channel” may also refer to a sub-channel, a sub-band, a resource pool or a SL BWP.

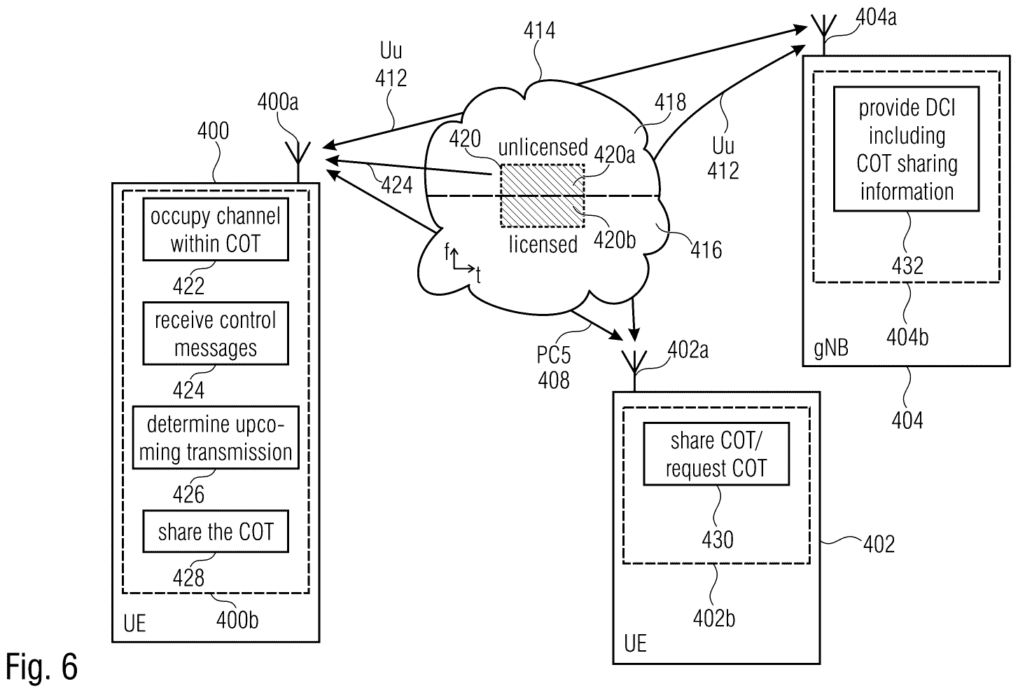

FIG. 6 illustrates a wireless communication system, like the one described above with reference to FIG. 1 to FIG. 3, for example a 3^{rd} generation partnership project, 3GPP, system or network. The wireless communication system includes user devices 400, 402 and one or more base station 404 operating in accordance with embodiments of the present invention. UE 400, also referred to as sidelink UE, SL-UE, comprises one or more antennas 400a and a signal processor 400b for performing one or more operations, for example operations involving the antenna 400a, like transmitting/receiving data, like payload data or control data, or inter-UE coordination (IUC) messages. UE 400 may communicate with other UEs, like UE 402, using the sidelink or PC5 interface, as is schematically illustrated at 408. UE 402, also referred to as sidelink UE, SL-UE, comprises one or more antennas 402a and a signal processor 402b for performing one or more operations, for example operations involving the antenna 400a, like transmitting/receiving data, like payload data and/or control data, or inter-UE coordination (IUC) messages. Moreover, UE 400 and/or UE 402 may be connected to a base station or gNB 404. The gNB 404 includes one or more antennas 404a for the wireless communication with the other network entities, like UEs 400 and/or 402, and a signal processor 404b. When operating in Mode 1, UE 400 and UE 402 receives via the Uu interface 412 resources allocated by the gNB 404 that are to be used by the UE for the communication over the sidelink 408. As mentioned above, when operating in Mode 2, UE 400 and/or UE 402 may not have a connectivity to the gNB 404 and a sensing plus access resource allocation or a random access-based resource allocation performed priori to performing a transmission.

FIG. 6 further illustrates, schematically, the spectrum 414, like the radio spectrum including the resources to be used for a communication within the wireless communication system or network. The resources available for the SL communication may comprise one or more of the following: one or more symbols, one or more time slots or subframes or frames, one or more resource blocks (RBs) or frequencies or carriers or subchannels or group of subchannels, one or more frequency bands. As is further illustrated, schematically, the spectrum 414 comprises the licensed spectrum 416 and the unlicensed spectrum 418. The licensed spectrum 416 is the part of the spectrum that is reserved for the wireless communication system including the UEs 400 and 402 as well as the base station 404. In other words, resources in the licensed spectrum are for exclusive use by this wireless system, as defined by regulatory bodies and entities. The unlicensed spectrum 418 includes resources that may be used by a plurality of wireless communication systems, for example by another wireless communication system in accordance with the 3GPP standard but operated by a different operator, or by systems using a different radio access technology, like WiFi or Bluetooth.

In accordance with embodiments, for the sidelink communication a resource pool 420, also referred to as sidelink resource pool, SL-RP, may be provided, and UE 400 is configured or preconfigured with the resource pool 420. Although the figure depicts only a single resource pool, multiple such resource pools may be configured or preconfigured. The resource pool may include resources from the unlicensed spectrum 418 only or from the licensed spectrum 416 only, or, as is depicted in the embodiment of FIG. 6, may comprise resources from the licensed spectrum 416 and from the unlicensed spectrum 420. In accordance with further embodiments, the resources in the unlicensed spectrum may be aggregated using carrier aggregation.

In accordance with embodiments of the present invention, UE 400, is a SL-UE communicating over the SL using resources from the unlicensed spectrum. UE 400 determines, based on received control messages concerning transmissions of one or more other network entities or devices, e.g., the further SL-UE 402 or the gNB 404 or any other device, such as an RSU, a WiFi device, etc., among the one or more network entities at least one network entity having an upcoming transmission, and share the COT with the at least one network entity.

For the following description of embodiments of the present invention UE 400 is assumed to be the above-mentioned COT initiating UE or initiating UE, while UE 402 is assumed to be the COT sharing UE or responding UE. The inventive approach is not limited to such a scenario, rather, as mentioned above, UE 400 may share the COT with one or more other network entities of the wireless communication network. For performing a transmission over the sidelink 408, for example towards one or more further UEs, like UE 402, UE 400, as is illustrated at 422, occupies the channel, i.e., resources spanning a certain time in the time domain and a certain frequency in the frequency domain. Occupying the channel further begins or starts a channel occupancy time, COT. In accordance with embodiments, UE 400 occupies the channel responsive to a successful channel access procedure, CAP, which UE 400 performed on the channel. In accordance with other embodiments, UE 400 may receive assistance, e.g., from gNB 404 or from any other network entity, so that it may not be required to perform a CAP on the channel. Rather, UE 400 may receive information about the resources or channel to use for a transmission, for example, gNB 404 may provide a grant which indicates the channel, like the resources in the unlicensed spectrum, to be used by UE 400 for performing a transmission on the sidelink. In either case, as is illustrated at 422, UE 400 occupies the channel for the transmission and the COT is started.

Further, as is illustrated at 424, UE 400 receives one or more control messages from other network entities, e.g., further UEs like UE 402 and/or from base stations like gNB 404, like one or more SCIs that are related to respective upcoming sidelink transmissions by one or more of the further UEs being in the vicinity of UE 400 and being capable to communicate also over the sidelink 408. In accordance with embodiments, UE 400 receives the SCIs prior to occupying the channel. UE 400, as is illustrated at 426, uses the one or more received control messages, like the one or more SCIs, so as to determine one or more of the further UEs which have an upcoming transmission to be performed during the COT. An upcoming transmission may be one or more future reserved resources, which are already known to a given UE, e.g., in case of a periodic reservation of resources in case a UE is aware of future transmissions that it has to take care of. Furthermore, these might also be future reservations for potential retransmissions, e.g., in case there are many UEs occupying the radio channel, a UE might already signal pre-reservations as to increase the probability of a successful transmission. Alternatively, an upcoming transmission may be a feedback transmission, e.g., HARQ feedback, to be performed by a given UE. Finally, a UE may have scheduling functionalities, e.g., by aiding other UEs to perform successful transmissions, and may pre-allocate resources for upcoming transmissions as a proxy for other UEs. In this way, other UEs may be aware of such future transmissions, and in case of certain conditions, e.g., having a lower priority, may refrain from performing a CAP in the unlicensed spectrum. In other words, UE 400 determines at 426 among the further UEs, one or more further UEs, like UE 402, having an upcoming transmission to be performed during the COT, and, as illustrated at 428, UE 400 shares the COT with the one or more further UEs, like UE 402, also referred to as the COT sharing UEs or the responding UEs. As mentioned earlier, when describing that a network entity, like responding UE 402, shares the COT initiated be UE 400, this means that the responding UE may use the channel occupied by the UE 400 within a part of the COT, e.g., for performing a transmission on the channel once the initiating UE completed its transmission of the channel. In accordance with embodiments, an upcoming transmission may be determined on the basis of the resource information derivable from the respective SCIs received from the plurality of further UEs communicating over the sidelink and being in the vicinity of UE 400.

UE 400 may perform its transmission on the occupied channel during a first part of the COT, and UE 402 may perform its upcoming transmission using all of or one or more parts of a second part of the COT. The second part of the COT may be the duration of the COT which remains after UE 400 completed its transmission on the occupied channel.

In accordance with embodiments, again, UE 400 may perform its transmission during the first part of the COT and shares the part of the COT which is not occupied by its transmission, the second part of the COT, only for a transmission of the PSFCH by the recipient of the transmission by UE 400, e.g., UE 402. Any remaining part of the COT is not shared by UE 400. For example, UE 400 may indicate the COT sharing for the second part of the COT within a control message associated with the transmission performed by UE 400 in the first part of the COT, e.g., an SCI message.

In accordance with the embodiments described so far, UE 400 shares the COT with UE 402, i.e., among the plurality of network entities that signaled an upcoming transmission, UE 400 selected UE 402 as the network entity to share the COT with. Accordingly, UE 402 receives the respective COT sharing information from UE 400 so as to use the channel occupied by UE 400 during at least a part of the COT that remains once UE 400 completed its transmission. For example, sharing the COT with only one other network entity may be performed by UE 400 in case the transmission performed by UE 400 is a frequency contiguous, non-interlaced transmission.

However, the present invention is not limited to sharing the COT with only one network entity. In accordance with further embodiments, UE 400 may determine more than one network entity to share to COT with. In addition to UE 402 in FIG. 6, UE 400 may determine another SL-UE (not depicted) or any other network entity to share the COT with. For example, sharing the COT with two or more other network entities may be performed by UE 400 in case the transmission performed by UE 400 is an interlaced transmission. In such a scenario, the number of network entities to share the COT with may be up to the number of interlaces of the interlaced transmission by UE 400. Nevertheless, the UE 400 may also share the COT with two or more other network entities in case of a non-interlaced transmission. In this case, if more than one UE grabs the shared COT, this might lead to interference or collisions among these transmissions. Nevertheless, this does not need to happen, in case the more than one UEs grabbing the COT are far apart from each other, so that they do not interfere. In another example, only one out of a set of potentially UEs eligible for using the shared COT also actually grabs the COT. This might be the case if other UEs for using the COT have lost interest in a transmission, since they might already have successfully transmitted their data, or, might have lost interest in a transmission since the COT does not provide enough transmission time for the data to transmitted, or, in case the maximum length of the COT is too short, such that the UE is not able to transmit its potential data within the COT, or, in case the packet delay is too large, in case the UE uses the COT for its transmission. In the latter case, a UE potentially transmits its data in another part of the spectrum, e.g., on a licensed carrier.

In accordance with embodiments, UE 400 may perform its transmission during the first part of the COT and share the second part of the COT which is not occupied by its transmission initially only for a transmission of the PSFCH by the recipient of the transmission by UE 400, e.g., UE 402. Only then, i.e., after sending the PSFCH, a further part of the second part of the COT may be used for a further PSSCH/PSCCH transmission, e.g., by the recipient and/or by a further network entity, like a further SL-UE. In other words, UE 400 may share
a first portion of the second part of the COT for a feedback transmission, PSFCH, by a network entity receiving the transmission of the UE in the first part of the COT, and
a second portion of the second part of the COT for a further transmission by the network entity or another network entity only after the feedback transmission is completed.

For example, UE 400 may indicate the COT sharing for the first and second portions of the second part of the COT within a control message associated with the transmission performed by UE 400 in the first part of the COT, e.g., a SCI message.

With regard to the just described embodiments, it is noted that the feedback transmission, PSFCH, may be performed by the recipient of the transmission by UE 400 in the first part of the COT, and/or by one or more further network entities. The benefit of sending the feedback from a different device, is that a feedback might be only a very short message, and that the device different to UE 400 might not have to perform a very long sensing procedure, or even LBT-less transmission within a shared COT, and thus, may transmit feedback information, such as a HARQ ACK/NACK feedback very quickly, without waiting for performing a successful CAP. In this case, delay and jitter is reduced, and even low latency transmissions may be possible to be performed in unlicensed part of the spectrum. Furthermore, this may make a transmission very robust, since more feedback may be transmitted, increasing the probability that a past transmitting-UE receives the corresponding feedback, e.g., HARQ feedback, in a timely matter.

Thus, the inventive approach at least alleviates or even avoids the drawbacks and problems experienced in conventional technology due to the limited possibilities for UE 400 to control which of the further network entities may actually share the COT. In accordance with the inventive approach, UE 400 takes into consideration also whether other network entities are to perform a transmission during the COT and may offer to use the channel it already occupied for such upcoming transmissions within the COT, e.g., during a part of the COT not employed by UE 400 for performing its transmission, thereby yielding the above-mentioned advantages.

In the embodiments described so far, it has been assumed that UE 400 which is to occupy the channel, thereby beginning the COT, evaluates control messages it received from further UEs or network entities also communicating over the sidelink, like SCI messages, so as to determine which of the surrounding UEs has an upcoming transmission, and therefore may use the channel occupied by the UE 400 for a part of the COT initiated by UE 400. In accordance with embodiments, UE 400 may identify the UE to share the COT with using the further UE's identification, ID, also referred to as the COT sharing UE. For example, the COT sharing ID may be a complete ID of a further UE, like UE 402 or another network entity, or a part of the ID, like the last n bits, or a checksum or a modulo value 2ⁿ, e.g., 16. In this way, the number of bits used for the ID is reduced, and thus the number of bits allocated within the SCI is small. Furthermore, an ID or partial bits of an ID may also be used as a group identifier, so that a certain part of the ID masquerades a certain group having group members, which are then potentially eligible for using the shared COT.

However, the present invention is not limited to such embodiments, rather control messages other than SCI messages may be employed for determining which of the surrounding UEs communicating over the sidelink may share the COT initiated by UE 400. For example, in accordance with other embodiments UE 400 may operate in Mode 1, i.e., may receive assistance from gNB 404 for the allocation of resources to be used for the transmission in the unlicensed spectrum. gNB 404 may provide a grant to UE 400 which indicates the resources or channel UE 400 is to employ for a transmission over the sidelink in the unlicensed spectrum. The grant may be provided using a control message, like a downlink control information message, DCI message, and in addition to the resource information the gNB 404 may also include into the control message, like the DCI, an identification of a certain UE with which UE 400 is to share the COT. For example, the DCI may include a UE ID of UE 402 in FIG. 6, thereby indicating to the COT sharing UE 400 that it is to share the COT with UE 402.

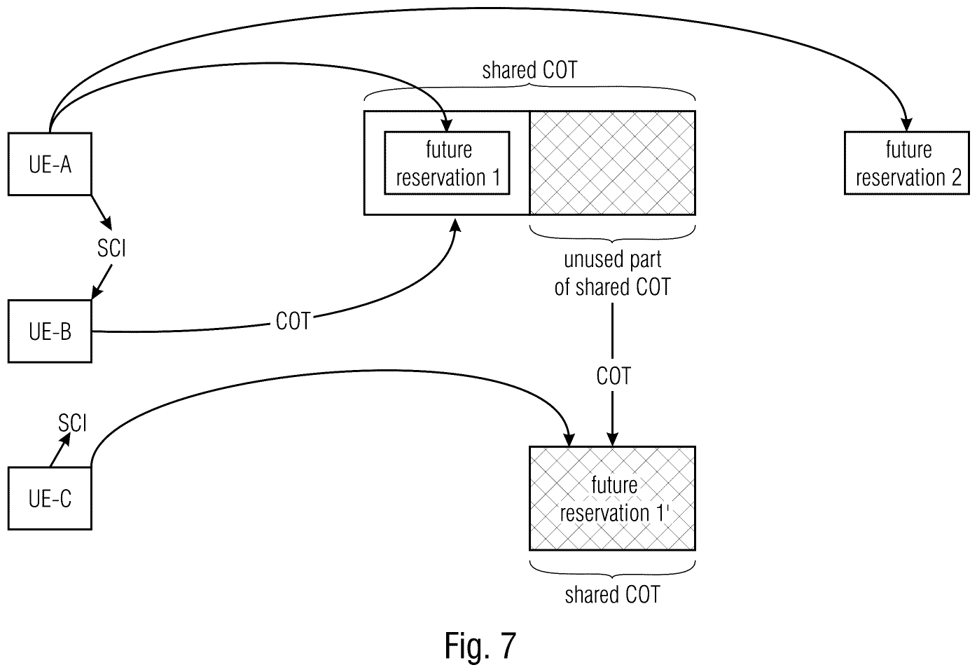

In accordance with embodiments the COT sharing approach may take advantage of future resource reservations which may be indicated in the SCI by future reservation information using a time resource indicator value, TRIV, and/or a frequency resource indicator value, FRIV. By taking into consideration future resource reservations, UE 400 may already know resource reservations in the future by decoding the previously received SCIs from the further UEs, and one of the further UEs may then share this information with yet further UEs depending on previously received decoded SCIs, as is schematically represented in FIG. 7 illustrating examples of the COT sharing for UEs with future reservations. As shown in this figure, UE-A might have two future reservations, future reservation 1 and 2, which it indicates in an SCI to its surrounding UEs. This may be in case the UE has periodic data or a data burst to transmit, and already is aware that future reservations are required. So in this case by sharing its SCI, a potential UE in its vicinity, UE-B, might become aware of UE-A's future reservation 1, and might share its COT with UE-A, so that UE-A does not have to perform a CAP or potentially an LBT-less CAP for data to be transmitted in its future reservation 1. In the case that UE-A only requires a partial COT of the shared COT of its transmission for future reservation 1, it may potentially share the remaining part of the COT with a third UE, e.g., UE-C, which might may use the full remaining COT or also only partial COT of the share COT for its transmission. Also in this case, the CAP to be performed by UE-C may take less burden, when it comes to the sensing procedure, that UE-C has to perform and may thus reduce the delay of a potential transmission in UE-C.

In accordance with further embodiments, in case future resource reservations are not considered, for example in case the TRIV or FRIV is turned off, for example by setting the parameter MaxNumPerReserve to 1, the COT sharing may operate as follows:
In case the SCI is for a periodic transmission, the COT initiating UE 400 may use the resource reservation periodicity to determine which of the further UEs to share the COT with. In this case, the COT initiating UE may derive the potential timing for a future transmission of another UE from the resource reservation periodicity and share the COT with UEs that have a periodicity that matches the time window of the COT.
In such a situation, by default, only the further UE that receives the unicast transmission from UE 400 may share with UE 400 the COT initiated by UE 400 since future transmissions of other UEs with regard to the transmit periodicities do not match the timeline of the COT to be shared.

In accordance with other embodiments, UE 400 may be configured by gNB 404 with configured grants. For such configured grants, the configured grant configuration may include information indicating a UE with which UE 400 is to share the COT. For example, the configured grant configuration may include COT sharing information indicating an ID of a UE or a group ID, like UE 402, that UE 400 is to pass the COT to, i.e., a COT sharing ID is provided, which indicates the ID, identification, of the UE, like UE 402, that is the COT sharing UE or responding UE with which UE 400 shares the COT.

In accordance with yet other embodiments, the one or more control messages on the basis of which UE 400 determines the one or more network entities with which it is to share the COT may also include or be transmitted via an IUC, inter-UE coordination, message, or an AIM, assistance information message.

In accordance with yet other embodiments, the control message may transmitted within one or more of: a 1^{st} stage SCI, a2^{nd} stage SCI, a Medium Access Control layer Control Element, MAC CE, a Radio Resource Control, RRC, message, e.g., a SL-RRC message.

In accordance with further embodiments, COT sharing may be selectively enabled or disabled in the wireless communication system or a part thereof, for example within the cell served by gNB 404 in which the UEs 400, 402 are located. In accordance with embodiments, UE 400 may receive a signaling indicating that COT sharing is enabled. For example, the signaling may comprise a DCI message, a resource pool, RP, configuration, a configured grant, CG, configuration, a sidelink control information, SCI, message, an IUC, inter-UE coordination, message or an assistance information message, AIM. Note that the AIM may also be send by a base station or RSU or another network entity aiding the CAP.

The signaling enabling/disabling the COT sharing may be a flag indicating if COT sharing is enabled or not, e.g., for certain resources or for a channel or interlace to be used by UE 400. For example, in case of a DCI message, a flag may be included in the DCI message indicating if COT sharing is enabled or not for a grant indicating the channel to be used by UE 400. For example, gNB 404 in FIG. 6 may provide a grant to UE 400 and include in the associated DCI message a flag which is set to a certain value so as to indicate whether COT sharing is enabled or not.

Furthermore, COT sharing might also be enabled/disabled only for certain UEs, e.g., have a certain ID, or for certain group of IDs, e.g., having a certain group ID.

In accordance with further embodiments, the signaling for indicating as to whether COT sharing is enabled or not, may comprise a resource pool, RP, configuration. For example, the sidelink resource pool configuration including information about the resources to be used for a sidelink communication, may contain additional information indicating whether COT sharing is allowed, for example, whether COT sharing is enabled or not for some or all of the resources from an unlicensed sidelink resource pool which includes the resources from the unlicensed spectrum to be used for the sidelink transmissions. In this case, COT sharing may only be allowed for a subset of resource, so that a threshold is signaled or configured or pre-configured which specifies this quota.

In accordance with yet further embodiments, the COT sharing enablement may be signaled using the above-mentioned configured grant configuration. For example, in addition to the COT sharing ID mentioned earlier, the configured grant configuration, in accordance with embodiments, may include a flag indicating whether COT sharing is allowed or not for the configured grant associated with the configured grant configuration. For example, on the basis of the COT sharing flag UE 400 in FIG. 6 may determine that the configured grant may be transmitted in an ongoing shared COT occupied by UE 400, and that the COT may also be shared and passed on to other UEs, like UE 402.

In accordance with further embodiments, in addition to the simple indication whether COT sharing is enabled or not, the signaling may further include an indication of a maximum COT time of the COT shared by UE 400. For example, a timer may be provided which indicates in units of time slots or mini-time slots or OFDM symbols the maximum COT time. In accordance with other embodiments, the maximum COT time may also be indicated by a time indicated in milliseconds or as an absolute value pointing to an end of the COT sharing duration in time. Indicating the maximum COT time is advantageous, since a potential UE using the shared COT may refrain from actually transmitting within the COT in case its required transmission time exceeds the COT. Alternatively, a potential UE using the shared COT may also decide based on the max. COT time, which data to transmit within the COT, e.g., if the COT is too short, it only transmits control or feedback data within the COT, and refrain from transmitting other data, e.g., PSSCH, within the COT.

In accordance with embodiments, the signaling may also indicate certain conditions when COT sharing is enabled. In other words, despite the signaling that COT sharing is basically enabled in the cell or system, UE 400 may decide on the basis of one or more of the certain conditions, whether to actually employ COT sharing when performing a transmission. For example, COT sharing may be enabled in case of one or more of the following:
A remaining COT time is above a predefined threshold.
For example, a timer may be provided which indicates in units of time slots or mini-time slots or OFDM symbols the remaining COT time. The remaining COT time may also be indicated by a time indicated in milliseconds or as an absolute value pointing to an end of the COT sharing duration in time. Indicating the remaining COT time allows the COT sharing UE, like UE 402, to judge whether its upcoming transmission may actually be transmitted on the channel occupied by UE 400 during the COT.
An upcoming transmission to be performed by a network entity, like UE 402, has a priority exceeding a predefined threshold.
For example, only packets which are transmitted with a certain priority, for example a high priority, may use a shared COT, thereby increasing the likelihood that a high priority transmission benefits from COT sharing.
An upcoming transmission to be performed by a network entity, like UE 402, has a particular identity, ID.
The UE sharing the COT may be aware of UEs of a certain identity, e.g., having a high priority, and thus picks certain UEs or a group UEs from this set of UEs. The ID or list of IDs may also be configured or pre-configured by a gNB or by another network entity, such that different UEs have different sets of configure or pre-configured IDs. The advantage of this approach is that a certain preference may be configured and, in this way, a certain set of UEs have a faster access to the radio channel. Another example where this may be applied is to an on-board unit which is mounted on a vehicle, which shares COT with potential UEs which are within or surrounding the vehicle, which may then be advantageous users of the radio spectrum.
An upcoming transmission to be performed by a network entity, like UE 402, belongs to a certain UE group.
The advantage of this is described in the bullet point above.
An upcoming transmission to be performed by a network entity, like UE 402, has enabled a feedback.
Since a feedback message is quite short, it may potentially be transmitted in a shorter CAP, e.g., even using LBT-less CAP, and may thus be transmitted faster. This increases robustness, e.g., by reducing the number of retransmissions of feedback data, and reduce latency for feedback traffic.
A transmission to be performed by the UE or an upcoming transmission to be performed by a network entity, like UE 402, has a predefined cast type.
This is advantageous since it reduces the amount signaling of COT sharing information, e.g., for unicast or broadcast, less bits have to be used for signaling since more than one UEs are addressed simultaneously.
A communication range of a transmission to be performed by the UE or of an upcoming transmission by a network entity, like UE 402, is below a predefined threshold.
This is advantageous since interference may be reduced, since only UEs of a certain reach may use the shared COT, reducing interference for other UEs when transmitting in the shared COT.
A network entity, like UE 402, is located at a distance less than a predefined threshold away from the UE, like within a minimum communication range, MCR.
This is advantageous since interference of transmissions in the shared COT may be reduced. Furthermore, only UEs having a short distance to a given UE may be configured to transmit using a smaller transmit power, which saves power for the UEs transmitting in the shared COT. This is of interest for power saving UEs, e.g., P-UEs.

As described above with reference to FIG. 6, once the COT initiating UE 400 determined the further UE, like UE 402, with which it shares the COT, UE 400 may signal a COT sharing control message to the certain further UE, like the responding UE 402. In accordance with embodiments, the COT sharing control message may include a sidelink control information, SCI, message, e.g., a 1^{st} stage SCI and/or a 2^{nd} stage SCI, or a Medium Access Control layer Control Element, MAC CE, or a Radio Resource Control, RRC, message, e.g., a SL-RRC message. The UE may provide COT sharing information within one or more of:
a 1st stage SCI and a MAC CE, with the 1^{st} stage SCI indicating a Physical Sidelink Shared Channel, PSSCH, that contains the MAC CE which includes the COT sharing information,
a 2^{nd} stage SCI and a MAC CE, with the 2^{nd} stage SCI indicating a Physical Sidelink Shared Channel, PSSCH, that contains the MAC CE which includes the COT sharing information,
a 1st stage SCI,
a 2^{nd} stage SCI,
a 1^{st} stage SCI and a 2^{nd} stage SCI,
a 1st stage SCI and a 2^{nd} stage SCI and MAC CE, with the 1^{st} stage SCI and/or the 2^{nd} stage SCI indicating a Physical Sidelink Shared Channel, PSSCH, that contains the MAC CE which includes the COT sharing information,
a MAC CE.

In accordance with further embodiments, the COT sharing information may also indicate a remaining COT time, for example by providing a remaining COT time countdown. For example, the COT initiating UE 400 sets a countdown to a maximum value and during each slot belonging to the same COT, the countdown may be decreased accordingly. Also, a COT timer may be indicated in a first stage SCI using the remaining bits, e.g., spare bits, in order to minimize the number of bits used for signaling this within the SCI. The timer may also be indicated in units of time slots or mini time slots or OFDM symbols or the remaining time may be indicated in milliseconds or as an absolute value pointing to an end of the COT sharing duration in time. Further, the COT sharing information may include a destination ID of the network entity, like UE 402, and/or a maximum COT time. The COT sharing information may be transmitted via unicast or groupcast or broadcast.

In accordance with further embodiments, despite identifying one or more network entities to share the COT with, UE 400 may decide to actually share the COT only in case one or more conditions are given. For example UE 400 may decide to share the COT dependent on one or more of the following conditions:
A remaining COT time is above a predefined threshold.
In this case, resource of the SL-U may be used efficiently, in case the remaining COT time is large enough to potentially be used by another UE. In case the COT time is too small, COT sharing might not be advantageous since signaling of the COT or COT-related information might cause and overhead which is not justified.
A transmission to be performed by the UE has a priority exceeding a predefined threshold.
This might be advantageous in case the UE is a potential recipient of data being transmitted in the shared COT, and it may select a certain UE for transmission such that it receives the data faster as to compared that the potential UE transmitting in the shared COT performs and independent CAP.
A transmission to be performed by the UE has enabled a feedback.
Since a feedback message is quite short, it may potentially be transmitted in a shorter CAP, e.g., even using LBT-less CAP, and may thus be transmitted faster. This increase robustness, e.g., by reducing the number of retransmissions of feedback data, and reduce latency for feedback traffic.
A transmission to be performed by the UE has a predefined cast type.
This is advantageous since it may reduce signaling of COT sharing information, e.g., for unicast or broadcast, less bits have to be used for signaling since more than one UEs are addressed simultaneously.
A remaining packet delay budget, PDB, of a transmission to be performed by the UE is above a predefined threshold.
This is advantageous, since if the COT is too short, it may not be possible to transmit the given data within the COT, and thus the resources is wasted.
A communication range of a transmission to be performed by the UE is below a predefined threshold.
This is advantageous since interference may be reduced, since only UEs of a certain reach may use the shared COT, reducing interference for other UEs when transmitting in the shared COT.
A number of slots of a transmission to be performed by the UE is above a predefined threshold.
This is advantageous, since if the COT is too short, it may not be possible to transmit the given data within the COT, and thus the resources is wasted.
The network entity is located at a distance less than a predefined threshold away from the UE, like within a minimum communication range, MCR.
This is advantageous since interference of transmissions in the shared COT may be reduced. Furthermore, only UEs having a short distance to a given UE may be configured to transmit using a smaller transmit power, which saves power for the UEs transmitting in the shared COT. This is of interest for power saving UEs, e.g., P-UEs.
The network entity is located within a certain zone or geo-location. COT sharing may be confined to a certain zone or area, in order to optimize resource usage in a specified area. This allows to reduce interference from COT sharing in certain areas, or increase resource usage in certain areas by allowing COT sharing. In case of interference from other non-3GPP networks in a given area, confining this feature to a certain geo-location or zone may be beneficial.

Further embodiments of the present invention concern a COT sharing or responding network entity, like UE 402. Responsive to receiving from UE 400 an indication that UE 400 shares the COT, UE 402 may share the channel occupied by UE 400 during the channel occupancy time initiated by UE 400, as indicated at 430 in FIG. 6.

Further embodiments of the present invention concern a COT sharing or responding network entity, like UE 402. As described above with reference to FIG. 6, UE 402 may also perform a sidelink, SL, communication using a channel comprising resources from an unlicensed spectrum. UE 402 may receive one or more control messages related to upcoming SL transmissions by one or more network entities of the wireless communication network, like UE 400, which, for the transmission, occupies a channel, as described above. UE 402 may be or may be not the actual recipient of the transmission by UE 400. In any case, UE 402 is aware that there is another UE that occupied a channel for a transmission so that also a COT began. UE 402 may try to obtain access to the channel during the COT for performing its transmission and, therefore, may request COT sharing from UE 400, as is indicated at 430 in FIG. 6. In other words, using the one or more control messages, like SCIs, UE 402 may determine at least one network entity of the wireless communication system, like UE 400, occupying a channel for a transmission within a channel occupancy time, COT, request the network entity, UE 400, to share the COT, and, if the COT is shared, perform its transmission within the shared COT using a full remaining COT or using only one or more parts of the remaining COT. For example, UE 402 may receive the one or more control messages prior to determining whether UE 402 or other more network entities occupy the channel.

In accordance with embodiments, the network entity, like UE 400 may perform the transmission on the occupied channel during a first part of the COT, and UE 402 performs its transmission using all of or one or more parts of a second part of the COT. The second part of the COT is a duration of the COT which remains after the transmission of UE 402 on the occupied channel is completed. For example, UE 402 may use a first portion of the second part of the COT for a feedback transmission, PSFCH, for the transmission of the network entity in the first part of the COT, and a second portion of the second part of the COT for a further transmission after the feedback transmission is completed. UE 402 may receive a COT sharing signaling for the first and second portions of the second part of the COT within a control message associated with the transmission performed by the network entity, UE 400, in the first part of the COT, e.g., a SCI message. In accordance with other embodiments, UE 402 shares or uses the second part of the COT only for a feedback transmission, PSFCH, for the transmission of UE 400 entity in the first part of the COT. It is noted that UE 400 may be or may not the recipient of the transmission of UE 402. In the latter case, UE 402 may transmit the feedback to another SL-UE, so that just the COT for the transmission is provided by another UE, e.g., UE 400, and that the COT is effectively utilized by a short feedback transmission. This enables UE 402 to transmit feedback to anther UE, which terminates a transmission and avoid further retransmission for this data transmission. Effectively, this reduces traffic in unlicensed spectrum and thus reduce overall interference in the unlicensed band. Furthermore, this increases the data rate by better spectrum utilization.

In accordance with the embodiments, the further UE 402 may decide to accept the COT sharing initiated by UE 400 or to request the COT sharing dependent on one or more conditions, e.g., dependent on one or more of the following:
A remaining COT time is above a predefined threshold.
In this case, the UE may only request COT sharing in case that its data transmission fits into a COT. In other cases, the UE may decide to transmit its data in a different band, e.g., licensed or unlicensed carrier.
A transmission to be performed by UE 402 and/or by the network entity, like UE 400, has a priority exceeding a predefined threshold.
This is advantageous since a high priority UE may potentially have a higher chance to receive COT sharing information, and thus, service differentiation may be possible for transmissions in shared bands.
A transmission to be performed by UE 402 and by the network entity, like UE 400, both have the same priority.
This may be beneficial in case both UEs, the UE sharing the COT as well as the UE transmitting within the share COT, are communicating with each other, and this constraint may be set, in order to reduce the number of potential UEs transmitting within the COT.
A transmission performed by UE 402 and/or by the network entity, like UE 400, has enabled a feedback.
Since a feedback message is quite short, it may potentially be transmitted in a shorter CAP, e.g., even using LBT-less CAP, and may thus be transmitted faster. This increases robustness, e.g., by reducing the number of retransmissions of feedback data, and reduce latency for feedback traffic.
A transmission performed by UE 402 and/or by the network entity, like UE 400, has a predefined cast type.
This reduces signaling, since also groupcast and/or unicast may be addressed. Furthermore, COT sharing may be confined to a certain cast type in order to reduce interference in shared bands.
A remaining packet delay budget, PDB, of a transmission to be performed by UE 402 is above a predefined threshold.
This is advantageous since a potential UE sharing its COT may only do so, in case the UE using the shared COT effectively fits its data within the COT, in order to use the shared resource efficiently.
A communication range of a transmission to be performed by UE 402 and/or by the network entity, like UE 400, is below a predefined threshold.
This is advantageous since interference may be reduced, since only UEs of a certain reach use the shared COT, reducing interference for other UEs when transmitting in the shared COT.

Further embodiments of the present invention concern a base station, like gNB 404 depicted in FIG. 6, which serves one or more user devices, like UEs 400, 402 which communicate with each other over the sidelink using resources from the unlicensed spectrum 418. The gNB 404 serves one or more user devices operating in accordance with the above-described embodiments of the present invention. In accordance with embodiments, when serving the COT sharing UE 400, the gNB 404 may signal to UE 400 a DCI message, as illustrated at 432 in FIG. 6, indicating the further UE, like UE 402, with which UE 400 is to share the COT. As described above, the DCI message may further include the flag indicating if COT sharing is enabled or not, for example for a grant indicating the channel to be used by UE 400, and/or a remaining COT time or a maximum COT time of the COT shared by UE 400.

As described above, embodiments of the present invention provide:
A user device, UE, for a wireless communication network, like a 3^{rd} Generation Partnership Project, 3GPP, network.
   In terms of the 5G NR standard the user device, UE, in the embodiments may correspond to a user equipment (UE) in the standard.
The UE is to perform a sidelink, SL, communication using a channel comprising resources from an unlicensed spectrum.
   In the 5G NR standard the NR sidelink on unlicensed spectrum (SL-U) is specified for NR Rel-18.
The UE is to occupy the channel within a channel occupancy time, COT.
   According to TS 38.212 (V17.5.0), 3.3 Abbreviations, the Channel occupancy time is abbreviated as COT.
   According to TS 37.213 (V17.1.0), 4 Channel access procedure, 4.0 General, a channel occupancy refers to transmission(s) on channel(s) by eNB/gNB/UE(s) after performing the corresponding channel access procedures in this clause. A ChannelOccupancy Time refers to the total time for which eNB/gNB/UE and any eNB/gNB/UE(s) sharing the channel occupancy perform transmission(s) on a channel after an eNB/gNB/UE performs the corresponding channel access procedures described in this clause. For determining a Channel Occupancy Time, if a transmission gap is less than or equal to, the gap duration is counted in the channel occupancy time. A channel occupancy time can be shared for transmission between an eNB/gNB and the corresponding UE(s).
Thus, the channel occupancy time in the embodiments may correspond to a COT, as defined in NR-U.
The UE is to receive one or more control messages.
   According to TS 38.212 (V17.5.0), 8.3 Sidelink control information on PSCCH, 8.3.1 1^{st}-stage SCI formats, 8.3.1.1 SCI format 1-A, SCI format 1-A is used for the scheduling of PSSCH and 2^{nd}-stage-SCI on PSSCH. The following information is transmitted by means of the SCI format 1-A:
      Frequency resource assignment

$$Frequency resource assignment - ⌈ {log}_{2} ( \frac{{N}_{subChannel}^{SL} ( {N}_{subChannel}^{SL} + 1 )}{2} ) ⌉$$

bits when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉$$

bits when the value of the higher layer parameter sl-MaxNumPerReserve is configured to 3, as defined in clause 8.1.5 of [6, TS 38.214].
   Time resource assignment—5 bits when the value of the higher layer parameter sl-MaxNumPerReserve is configured to 2 otherwise 9 hits when the value of the higher layer parameter sl-MaxNumPerReserve is configured to 3, as defined in clause 8.1.5 of [6, TS 38.214].
At least one of the control messages is related to one or more upcoming SL transmissions by one or more network entities of the wireless communication network
   According to TS 38.331 (V17.3.0), 6.3.5 Sidelink information elements, sl-MaxNumPerReserve indicates the maximum number of reserved PSCCH/PSSCH resources that can be indicated by an SCI.
Thus, the UE reads a control message from another UE by decoding a 1st-stage SCI, which indicates within the FRIV/TRIV future reservations.
The UE is to determine, using the one or more control messages, among the one or more network entities, at least one network entity having an upcoming transmission.
   According to TS 38.212 (V17.5.0), 8.3.1.1 SCI format 1-A, SCI format 1-A is used for the scheduling of PSSCH and 2^{nd}-stage-SCI on PSSCH. The following information is transmitted by means of the SCI format 1-A: . . . 2^{nd}-stage SCI format—2 bits as defined in Table 8.3.1.1-1 . . .
Thus, the UE in the embodiments may detect an upcoming transmission by decoding a 1^{st}-stage SCI from the said UE. See also spec elements for the claim element 4 above.
   According to TS 38.212 (V17.5.0), 8.4.1.1 SCI format 2-A, SCI format 2-A is used for the decoding of PSSCH, with HARQ operation when HARQ-ACK information includes ACK or NACK, when HARQ-ACK information includes only NACK, or when there is no feedback of HARQ-ACK information. The following information is transmitted by means of the SCI format 2-A:
      HARQ process number—bits.
      New data indicator—1 bit.
      Redundancy version—2 bits as defined in Table 7.3.1.1.1-2.
      Source ID—8 bits as defined in clause 8.1 of [6, TS 38.214].
      Destination ID—16 bits as defined in clause 8.1 of [6, TS 38.214].
      HARQ feedback enabled/disabled indicator—1 bit as defined in clause 16.3 of [5, TS 38.213].
      Cast type indicator—2 bits as defined in Table 8.4.1.1-1 and in clause 8.1 of [6, TS 38.214].
      CSI request—1 bit as defined in clause 8.2.1 of [6, TS 38.214] and in clause 8.1 of [6, TS 38.214].
Thus, the network entity in the embodiments may correspond to the detected Source ID in the 2^{nd}-stage SCI 2-A in the standard.
The UE is to share the COT with the at least one network entity.
   According to RAN1 #109-e (09-20 May 2022) UE-to-UE COT sharing is supported in NR sidelink operation in a shared channel (SL-U).
   According to RAN1 #112 (27 Feb.-3 Mar. 2023) a responding UE's PSSCH/PSCCH transmission(s) within RB set(s) corresponding to a shared COT is intended for the COT initiating UE when,
      In the case of unicast from the responding UE, when the source and destination IDs contained in the responding UE's PSCCH/PSSCH match to the destination and source IDs from a COT initiator's unicast transmission that included COT sharing information, or match to the additional ID(s) included in the COT sharing information (if supported)
      In the case of groupcast or broadcast from the responding UE, when the destination ID contained in the responding UE's PSCCH/PSSCH matches to the destination ID from a COT initiator's groupcast or broadcast transmission that included COT sharing information, or matches to the additional ID(s) included in the COT sharing information (if supported)
Thus, the UE in the embodiments may correspond to the COT initiator in the agreement, and the UE in the embodiments may transmit to one of the destination IDs as written in the agreement.

### General

Embodiments of the present invention have been described in detail above, and the respective embodiments and aspects may be implemented individually or two or more of the embodiments or aspects may be implemented in combination.

It is noted that the inventive approach is not limited to CGs or DGs. In accordance with other embodiments, a grant may be less than a CG or DG, or it may just be a broad kind of resource coordination, e.g., which subband or subchannel to use or to avoid.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

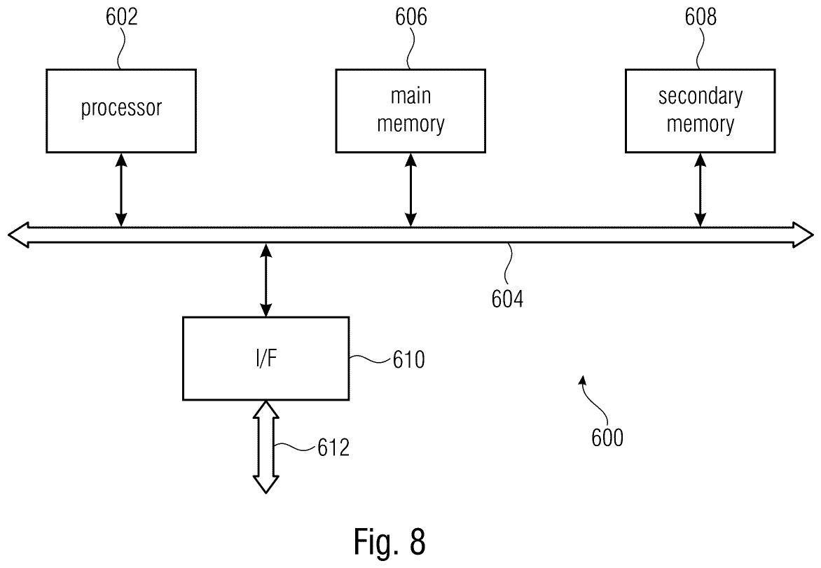

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 8 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A user device, UE, for a wireless communication network, like a 3^{rd} Generation Partnership Project, 3GPP, network,
wherein the UE is to perform a sidelink, SL, communication using a channel comprising resources from an unlicensed spectrum,
wherein the UE is to occupy the channel within a channel occupancy time, COT,
wherein the UE is to receive one or more control messages, wherein at least one of the control messages is related to one or more upcoming SL transmissions by one or more network entities of the wireless communication network, and
wherein, the UE is to
determine, using the one or more control messages, among the one or more network entities, at least one network entity comprising an upcoming transmission, and
share the COT with the at least one network entity.

2. The user device, UE, of claim 1, wherein the UE is to share the COT with
one network entity, in case of a frequency contiguous, non-interlaced transmission by the UE and/or by the network entity, or
more than one network entity, up to the number of interlaces, in case of an interlaced transmission by the UE and/or by the network entities, or
more than one network entity in case of a feedback transmission, e.g. over the Physical Sidelink Feedback Channel, PSFCH.

3. The user device, UE, of claim 1, wherein the UE is to perform a transmission during a first part of the COT, and the network entity is to perform the upcoming transmission using all of or one or more portions of a second part of the COT, the second part of the COT comprising a duration of the COT which remains after the transmission of the UE is completed.

4. The user device, UE, of claim 3, wherein the UE is to share
a first portion of the second part of the COT for a feedback transmission, like a PSFCH, by a network entity receiving the transmission of the UE in the first part of the COT and/or by one or more other network entities, and/or
a second portion of the second part of the COT for a further transmission by the network entity or another network entity only after the feedback transmission is completed.

5. The user device, UE, of claim 4, wherein the UE is to indicate the COT sharing for the first and/or second portions of the second part of the COT within a control message associated with the transmission performed by the UE in the first part of the COT, e.g., an SCI message, or a control message associated with the transmission of an earlier portion within the second part of the COT, e.g., via an SCI message.

6. The user device, UE, of claim 3, wherein the UE is to share the second part of the COT with a network entity receiving the transmission from the UE in the first part of the COT for one or more of the following:
a feedback transmission, PSFCH,
a data transmission, PSSCH,
a control signaling, PSCCH,
a transmission of demodulation references symbols, DMRS,
an automatic gain control signal, AGC.

7. The user device, UE, of claim 6, wherein the UE is to indicate the COT sharing for the second part of the COT within a control message associated with the transmission performed by the UE in the first part of the COT, e.g., an SCI message.

8. The user device, UE, of claim 6, wherein the feedback transmission, PSFCH, is performed by the network entity receiving the transmission performed by the UE in the first part of the COT, or by one or more further network entities.

9. The user device, UE, of claim 1, wherein
within a time interval following the transmission by the UE, some or all of the upcoming transmissions by the network entities are performed at different times, and
the UE is to share the COT with a network entity performing the upcoming transmission at a particular point within the time interval, wherein the particular point comprises an earliest point or any other later point within the time interval.

10. The user device, UE, of claim 9, wherein the time interval is defined by the remaining COT timer or by the COT duration.

11. The user device, UE, of claim 1, wherein the UE is to occupy the channel for the COT responsive to
receiving from one or more of the network entities a grant indicating the channel or an interlace or a PSFCH index to be used by the UE, and/or
determining resources to be used within a channel based on sensing and resource selection procedures, and/or
a successful channel access procedure, CAP, performed by the UE on the channel.

12. The user device, UE, of claim 1, wherein
the one or more control messages comprise a sidelink control information, SCI, message, and
the UE is to determine, using a resource reservation or resource assignment information, e.g., a Time Resource Indicator Value, TRIV, and/or a Frequency Resource Indicator Value, FRIV, and/or an inter-UE coordination, message IUC, in the SCI message, whether an upcoming transmission by a network entity is to be performed during the COT.

13. The user device, UE, of claim 1, wherein, for sharing the COT, the UE is to send a COT sharing control message to the network entity.

14. The user device, UE, of claim 13, wherein the COT sharing control message is transmitted within one or more of:
a sidelink control information, SCI, message, e.g., a 1^{st} stage SCI and/or a 2^{nd} stage SCI,
a Medium Access Control layer Control Element, MAC CE,
a Radio Resource Control, RRC, message, e.g., a SL-RRC message.

15. The user device, UE, of claim 14, wherein the UE is to provide COT sharing information within one or more of:
a 1st stage SCI and a MAC CE, with the 1^{st} stage SCI indicating a Physical Sidelink Shared Channel, PSSCH, that comprises the MAC CE which comprises the COT sharing information,
a 2^{nd} stage SCI and a MAC CE, with the 2^{nd} stage SCI indicating a Physical Sidelink Shared Channel, PSSCH, that comprises the MAC CE which comprises the COT sharing information,
only a 1st stage SCI,
only a 2^{nd} stage SCI,
a 1^{st} stage SCI and a 2^{nd} stage SCI,
a 1st stage SCI and a 2^{nd} stage SCI and MAC CE, with the 1^{st} stage SCI and/or the 2^{nd} stage SCI indicating a Physical Sidelink Shared Channel, PSSCH, that comprises the MAC CE which comprises the COT sharing information,
only a MAC CE.

16. The user device, UE, of claim 13, wherein the COT sharing information comprises
a destination ID of the network entity, and/or
a feedback indicator, e.g. PSFCH indicator,
a remaining COT time, and/or
a maximum COT time.

17. The user device, UE, of claim 16, wherein the COT sharing information is transmitted via unicast or groupcast or broadcast.

18. The user device, UE, of claim 1, wherein
the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity, and/or
the network entity comprises one or more of a further UE, like a UE or a SL UE or a group leader UE, GL-UE, or a base station, like a macro cell base station or a small cell base station or a central unit of a base station or a distributed unit of a base station or an Integrated Access and Backhaul, IAB, node, or a road side unit, RSU, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

19. A wireless communication system, like a 3^{rd} Generation Partnership Project, 3GPP, system, comprising at least one user device, UE,
wherein the at least UE is to perform a sidelink, SL, communication using a channel comprising resources from an unlicensed spectrum,
wherein the at least UE is to occupy the channel within a channel occupancy time, COT,
wherein the at least UE is to receive one or more control messages, wherein at least one of the control messages is related to one or more upcoming SL transmissions by one or more network entities of the wireless communication network, and
wherein, the at least UE is to
determine, using the one or more control messages, among the one or more network entities, at least one network entity comprising an upcoming transmission, and
share the COT with the at least one network entity.

20. A method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises:
occupying the channel within a channel occupancy time, COT,
receiving one or more control messages, wherein at least one of the control messages is related to one or more upcoming SL transmissions by one or more network entities of the wireless communication network,
determining, using the one or more control messages, among the one or more network entities, at least one network entity comprising an upcoming transmission, and sharing the COT with the at least one network entity.
